(19) United States
(12) Patent Application Publication
(10) Pub. No.: US 2017/0020778 A1
(43) Pub. Date: Jan. 26, 2017

(54) A MACHINE AND A METHOD FOR FASCIA TREATMENT

(71) Applicant: Atlasbalans AB, 191 41 Sollentuna (SE)

(72) Inventor: Hans Bohlinä, Sollentuna (SE)

(21) Appl. No.: 15/123,774

(22) PCT Filed: Mar. 6, 2015
(86) PCT No.: PCT/SE2015/000012

§ 371 Date: Sep. 6, 2016

(30) Foreign Application Priority Data
Mar. 7, 2014 (SE) 1400126-7

(51) Int. Cl. A61H 23/02

(52) U.S. Cl. CPC A61H 23/0254; A61H 2023/002

(57) ABSTRACT

The handheld machine and method are for the treatment of fascia deficiencies on human beings and animals. The machine has a motor driver and a motor driven to produce a wave cam through a cam transmission operating on a plunger thrusting back and forth in predetermined low frequencies.

### TECHNICAL FIELD

The present invention pertains to a handheld machine, and a method adapted to treatment of fascia deficiencies on human beings, and animals.

### BACKGROUND ART

New scientific research has been targeted on the fascia/muscular connective tissue, and its influence on body strains on both human beings, and animals having such as mammals. Fascia is for instance surrounding muscles from foot to head.

If skin from humans, and animals is removed, the first layer of fascia is super fascia, the next is scapas fascia, and then the deep fascia. These layers can adhere/glue to each other, and create deficiencies causing painful problems to a body such as headache, back pain, knee pain, neck pain, and pain almost everywhere a body has been mistreated by repeated movements, blows, wrong body postures, other injuries and the like. Also, pain and fascia deficiencies can have their issue from surgery whereby the fascia is punctured, and thus the fascia layers can adhere to each other or be twisted causing pain.

The pain induced from injury may spread along the fascia to other body parts apart from where the injury actually occurred. Current treatment for fascia injuries are almost entirely directed to cure the actual spot where the injury occurred through skin massage and/or shock wave treatment by a machine with a plunger hammering/pounding the injured spot to soften muscles and/or ligaments, or twisted/misplaced tendons.

A shock wave machine is disclosed through the US patent application document US2013261516 A1, which is utilized for the mentioned massage treatment of injured body spots.

In a 2006 study conducted by Fauna Communications, researchers found that the frequency of a cat's purr (between 25 and 140 Hz), convers the same frequencies that are therapeutic for bone growth and fracture healing, pain relief, swelling reduction, wound healing, muscle growth and repair, tendon repair, and mobility of joints.

A link www.youtube.com/watch?v=vIFDwDdGnhQ shows about current findings of the importance of fascia, and the function of fascia.

### SUMMARY OF THE INVENTION

The present invention has as one aim among many to provide a handheld machine to treat pain induced by fascia deficiencies on human beings, and animals. Hereby, the machine is utilized for deep wave treatment of the entire string/meridians of myofascia connected to an injured fascia spot, i.e. not only the injured spot. To be able to achieve this objective the fascia has to be treated with different frequencies, depending on where on the fascia, the machine wave treatment is applied. Frequencies applied should be in the lower range of the Hertz scale such as for instance, the range 1 Hz to 60 Hz, this to enable a deep wave treatment to reach fascia surrounding muscles, not just the upper layer reachable to a local target therapy massage and/or shock wave treatment. Shock wave treatment, if utilized improper can cause more damage than good. Also, the present invention provides different time periods for the operation by frequencies utilized.

Hence, the present invention sets forth a handheld machine adapted to treatment of fascia deficiencies on human beings, and animals, the machine having a motor driver and a motor driven to produce a wave cam through a transmission operating on a plunger thrusting back and forth in predetermined low frequencies, comprising:

a plunger frequency control circuit, which operates in at least three modes a dual, a fixed pattern, and a stochastic pattern mode, the modes being induced by at least one of a computer program, and programmed by a user of the machine;

the dual mode, generating a preset higher, and lower frequency out of the low frequencies, and preset time periods;

the preset fixed pattern waves mode, being generated to create the pattern needed out of at least one of two, and three frequencies and times; and

the stochastic pattern waves, being generated to create a pattern, which operates on at least one of two preset frequencies, and times providing that the plunger operates in a continuous sequence of random frequencies, and times in the stochastic mode.

In one embodiment of the present invention, the lower frequency region is from 1 Hz to 60 Hz with time periods between 0.5 to 5 sec. for the preset time periods.

Another embodiment provides that the high and low preset frequencies, if they are set to the same value, are generating a stable frequency.

Moreover, the present invention sets forth a method to a handheld machine adapted to treatment of fascia deficiencies on human beings, and animals, the machine having a motor driver and a motor driven to produce a wave cam through a transmission operating on a plunger thrusting back and forth in predetermined low frequencies, comprising:

controlling a plunger through a frequency control circuit, which operates in at least three modes a dual, a fixed pattern, and a stochastic mode, the modes being induced by at least one of a computer program, and programmed by a user of the machine;

generating through the dual mode a preset higher, and lower frequency out of the low frequencies, and preset time periods;

generating the preset fixed pattern waves mode to create the pattern needed

generating the stochastic pattern waves to create a pattern, which operates on at least one of two preset frequencies, and times providing that the plunger operates in a continuous sequence of random frequencies, and times in the stochastic mode; and

adapting the frequencies, and time periods to treat entire meridians of fascia connecting to a deficient fascia spot.

The attached dependent method claims of the present invention adhere to the attached dependent machine claims.

### A BRIEF DESCRIPTION OF THE DRAWINGS

Henceforth, reference is had to the accompanying drawings throughout the present description for a better understanding of the present inventions embodiments, and given examples, wherein:

FIG. 1 schematically illustrates a block diagram of a machine, in one embodiment, in accordance with the present invention; and

FIG. 2 schematically illustrates the machine of FIG. 1 in one possible actual appearance, in one embodiment, according to the present invention.

### DETAILED DESCRIPTION OF PREFERRED EMBODIMENTS

The present invention regards a handheld machine to treat pain induced by fascia deficiencies on human beings, and animals such as mammals. Hereby, the machine is utilized for deep wave treatment of the entire string of fascia connected to an injured fascia spot, i.e. not only the injured spot. To achieve this objective the fascia has to be treated with different frequencies, depending on where on the fascia, the machine wave treatment is applied. Frequencies applied should be in the lower range of the Hertz scale such as for instance, the range 1 Hz to 60 Hz, this to enable the wave treatment to reach fascia surrounding muscles, not just the upper layer reachable to a local target therapy massage and/or shock wave treatment. Shock wave treatment if utilized improper can cause more damage than good. Also, the present invention provides different time periods for the operation of frequencies utilized. Hence, the treatment regards for instance fascia and myofascial changes, on the superficial backline, superficial front line, the functional lines, superficial front arm line.

Understanding the superficial back Line as a whole gives insights into hamstring problems that you cannot get from considering the hamstrings alone. The spiral line shows how to resolve rotational compensations in a way that no analysis of any single muscle can give. Thus the present invention deep wave treatment machine is deployed along the myofascial meridians not just where the fascia is damaged. For example, the shoulders involve six myofascia meridians.

Fascia and myofascia is a body tissue that provides forms to the entire body and is responsible of intercellular communication and cellular metabolism. The fascia is like a matrix of cells. Fascia is the biological fabric that holds us together. A human being has about 70 trillion cells all humming in relative harmony; fascia is the 3-D spider web of fibrous, gluey, and wet proteins that hold them all together in their proper placement.

Moreover fascia has a wider definition: all the collagenous-based soft-tissues in the body, including the cells that create and maintain that network of extra-cellular matrix (ECM). That definition includes all the tissues traditionally designated as ‘fascia’ in classical anatomy, plus all the other actual; tendons, ligaments, bursae, and all the fascia in and around the muscles endomysium, perimysium, epimysium. Also included would be the fascia around the organs: the coelomic bags that hold the organs in the peritoneum and mesentery in your abdominal cavity, the mediastinum, pericardium, and pleura that hold the organs in the chest cavity, and the membranes dura and pia and perineuria that surround the brain, spinal cord, and peripheral nerves.

If the fascia lost its tension, the entire body would fall into the fetal position.

Through the book “Anatomy Trains, Myofascial Meridians for Manual & Movement for Therapists”, Thomas W. Meyers teaches the importance of fascia in therapy.

A treatment of horse's fascia during tests with the machine of the present invention has been very successful, and in some cases cured a horse with a leg deficiency during a twenty minute treatment session. More to read about fascia, and massage of horses can be found at the link http://www.equine-equilibrium.com/myofascialrelease.php.

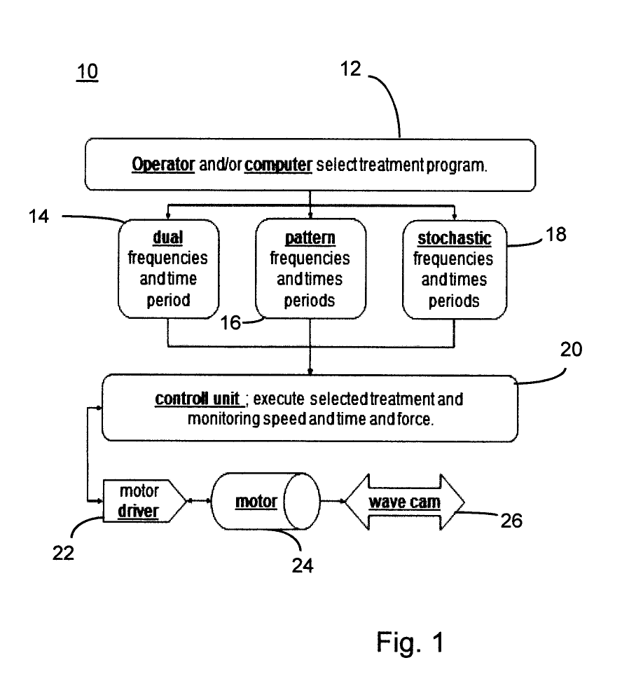

FIG. 1 schematically illustrates a block diagram of a machine 10 in one embodiment in accordance with the present invention. An operator 12 choses through a machine 10 buttons/touchpad or the like a program of his/her owns choice, or a stored computer program for a selected treatment session. Preferably there are at least three modes of operations 14, 16, 18, which can be chosen by the operator. Those are the dual mode 14, where frequencies, and time periods are chosen by the operator 12, a stored pattern computer program with predetermined frequencies and time periods for the machine 10 to operate within. A second fixed pattern wave mode 16 is generated to create the pattern needed out of two, three or more frequencies and times. Furthermore, a third mode is available as a stochastic mode 18 changing frequencies, and time periods randomly from a preprogrammed stochastic mode 18. It is of course anticipated that a computer, micro controller or the like, with its necessary peripheral devices is comprised in the machine 10 to execute the programs, and modes of operation mentioned.

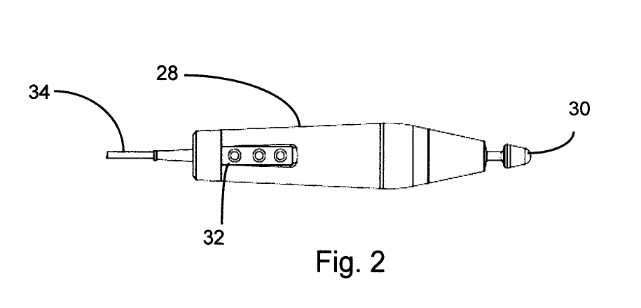

Depending on the chosen mode a control unit 20 executes the selected/chosen operator 12 treatment by monitoring speed, time, and force applied by the machine 10, when utilized during treatment. A motor driver 22 controlled by the control unit 20 applies the control of a motor 24, which drives a transmission, for instance a cam 26 generating waves to a plunger 30, depicted in FIG. 2.

In FIG. 2, the machine 10, 28 in FIG. 1 is depicted in one possible actual appearance, in accordance with the present invention. Thus, the machine 28 has a plunger 30 driven by the motor 24 through a transmission for instance as simple as a cam 26 (cam not shown). This cam 26 provides axial movements back and forth to the plunger 30 according to the set modes of operation 14, 16, 18. Moreover, FIG. 2 depicts a set of buttons 32 utilized to preset the operation of the wave machine 10, 28 in accordance with the chosen mode of operation 14, 16, 18. Also depicted in FIG. 2 is the power cord 34 delivering electric power to the machine 10,28.

Furthermore, the machine 10, 28 is utilized through a method for usage claimed by the present invention, and two machines 10, 28 can be utilized at the same time, held in each one hand of the operator 12, to follow the myofascia meridians.

A deep wave massage with a machine 10, 28 of the present invention, through the connective tissues (fascial, myofacial/superfascial chains) releases tensions in muscles and other complications in movement and the like. Low frequencies for instance in the range of 1 to 60 Hz should be applied by the plunger to produce deep body waves reaching the entire fascia. The present invention is not restricted to the highest low frequency of 60 Hz mentioned, slight higher frequencies maybe utilized for some applications, for instance a cat utilizes frequencies as high as 140 Hz to keep fit.

The attached set of claims determines other possible embodiments of the present invention to a person skilled in the art of the present technical field.

I claim:

1. A handheld machine adapted to treatment of fascia deficiencies on human beings, and animals, said machine comprising:
a motor power supply controlled by a control unit and a motor driven to produce a wave cam through a transmission operating on a plunger thrusting back and forth in predetermined low frequencies, said frequencies being within a span of 1 to 60 Hz, and time periods for said back and forth thrusting, comprising:
a plunger frequency control circuit, which operates in at least three modes a dual frequency wave mode, a fixed frequency pattern wave mode, and a stochastic frequency pattern wave mode, said modes being induced by a computer program, programmed by a user of said machine;
said dual mode, generating a preset higher, and lower frequency out off said low frequencies within said span of 1 to 60 Hz, and preset time periods for said back and forth thrusting;
said preset fixed frequency pattern wave mode, being generated to create the frequency pattern needed out of at least one of two, and three frequencies within said span of 1 to 60 Hz and preset time periods for said back and forth thrusting; and
said stochastic wave mode, being generated to create a frequency wave pattern, which operates on at least one of two preset frequencies within said span of 1 to 60 Hz, and times for said back and forth thrusting providing that said plunger operates in a sequence of random frequencies, and times in said stochastic mode.

2. A machine according to claim 1, wherein said time periods are set between 0.5 to 5 seconds for said preset time periods.

3. A machine according to claim 1, wherein said high and low preset frequencies, when the frequencies are set to the same value generating a stable frequency.

4. A method to operate a handheld machine adapted to treatment of fascia deficiencies on human beings, and animals, said machine having a motor power supply controlled by a control unit and a motor driven to produce a wave cam through a transmission operating on a plunger thrusting back and forth in predetermined low frequencies, said frequencies being within the span of 1 to 60 Hz, and time periods for said back and forth thrusting, comprising:
controlling a plunger through a frequency control circuit, which operates in at least three modes a dual frequency pattern wave mode, a fixed frequency pattern wave mode, and a stochastic frequency pattern wave mode, said modes being induced by a computer program, and programmed by a user of said machine;
generating through said dual mode a preset higher, and lower frequency out off said low frequencies within the span of 1 to 60 Hz, and preset time periods for said back and forth thrusting;
generating said preset fixed frequency pattern wave mode to create the pattern needed out of at least one of two, and three frequencies within said span of 1 to 60 Hz and preset time periods for said back and forth thrust;
generating said stochastic frequency pattern mode waves to create a frequency pattern, which operates on at least one of two preset frequencies within said span of 1 to 60 Hz, and preset time periods for said back and forth thrusting providing that said plunger operates in a sequence of random frequencies, and time periods in said stochastic frequency pattern wave mode; and
adapting said frequencies, and time periods to treat entire meridians of fascia connecting to a deficient fascia spot.

5. A method according to claim 4, wherein said time periods are between 0.5 to 5 sec. for said preset time periods.

6. A method according to claim 1, wherein said high and low preset frequencies, when the frequencies are set to the same value generating a stable frequency.
